(19) United States
(12) Patent Application Publication
(10) Pub. No.: US 2002/0182449 A1
(43) Pub. Date: Dec. 5, 2002

(54) Coating for cooking utensils and tableware

(76) Inventors: Ryan Neal, Midland, GA (US); Andrew Kahler, Fortson, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/164,182

(22) Filed: Jun. 5, 2002

Related U.S. Application Data
(60) Provisional application No. 60/296,051, filed on Jun. 5, 2001.
(60) Provisional application No. 60/311,722, filed on Aug. 10, 2001.

(51) Int. Cl. B05D 3/00; B05D 1/36

(52) U.S. Cl. 428/698; 427/299; 427/402

(57) ABSTRACT

Cooking utensils, serving utensils, eating utensils, barbecue utensils or other related tableware that are coated either entirely or partially, such as at the edges with a coating that provides certain benefits to the utensils or tableware are disclosed.

### CROSS REFERENCE TO RELATED APPLICATION

This document claims priority to provisional U.S. Patent Application entitled “Coating For Cooking Utensils And Tableware,” assigned serial No. 60/296,051, and filed Jun. 5, 2001, which is incorporated herein by reference. This document further claims priority to provisional U.S. Patent Application entitled “Coating For Cookware And Tableware,” assigned serial No. 60/311,722, and filed Aug. 10, 2001, which is also incorporated herein by reference.

### TECHNICAL FIELD

The present invention is generally related to utensils and tableware and, more particularly, is related to a product and method for improving various characteristics of utensils and tableware.

### BACKGROUND OF THE INVENTION

There are many conventional cooking utensils, eating utensils and tableware currently available. Certain food items, particularly delicate ones such as fish steaks, filets and croquettes are difficult to lift and remove from cooking surfaces such as frying pans, grills and barbecue surfaces, and to invert and deposit onto cooking and other surfaces such as serving trays, platters and cutting boards. These food items when partly or fully cooked tend to break up easily during one or more of such maneuvers. Such delicate food items tend to lack cohesiveness and can stick to and be difficult to remove in one piece from their cooking surfaces or the cooking, serving or eating utensils. For example, if the foods are over-cooked or lack juices, or if the foods are not displaced and/or inverted sufficiently they may stick to these surfaces.

Application of non-stick coatings to cooking vessels is well-known. Adhesion of non-stick coatings, e.g., non-stick coatings such as the TEFLON® brand non-stick coating, which are applied to a substrate metal, is improved by first flame spraying metal droplets onto the substrate layer to provide a rough surface for the non-stick coating to adhere to. This coating, however, typically must be thin. While a thick coating of the non-stick material will increase the non-stick performance of the interior surface of the cooking vessel, a thick coating will also reduce the scratch resistance of the interior surface of the cooking vessel. Thus, a relatively thin coating is desired to achieve maximum scratch resistance. Thin coatings of non-stick material are desired to enhance durability, while thick coatings are desired to enhance the non-stick performance of the cooking utensil. Because many of the utensils used in cooking are made of metal and are substantially harder than the non-stick coating, it is generally desirable to have a non-stick coating which is durable enough to withstand the abrasion of cooking utensils while retaining good non-stick characteristics. Coatings have typically been applied to entire cookware and tableware surfaces; however, rather than just the relevant portions needed for use.

Heretofore, there has not been satisfactory cooking, eating, or serving utensils or other tableware for easily lifting partly or fully cooked delicate food items from cooking or other surfaces and for inverting and depositing them in one piece onto cooking and/or other surfaces. Thus, a heretofore unaddressed need exists in the industry to address the aforementioned deficiencies and inadequacies.

### SUMMARY OF THE INVENTION

The present invention provides an apparatus for use as a cooking utensil or as tableware and method for producing cooking utensils or tableware.

Briefly described, one embodiment of the apparatus, among others, can be implemented as follows. A utensil or piece of tableware including a novel coating applied thereto. In an alternative embodiment, the novel coating or a conventional coating may be applied only to the working edge of the utensil or working portion of the tableware.

The present invention can also be viewed as providing methods for producing cooking utensils or tableware. In this regard, one embodiment of such a method, among others, can be broadly summarized by the following steps: providing the utensil, and applying the coating of the present invention to the utensil. Another such method can be broadly summarized by the following steps: providing a utensil or piece of tableware;

and either applying the coating to the entire surface and then ablating or etching off the portion not on the working edge, or applying the coating only to the working edge in accordance with a stencil, screen or other means of depositing the coating only on the working edge of the utensil.

Other methods, features, and advantages of the present invention will be or become apparent to one with skill in the art upon examination of the following drawings and detailed description. It is intended that all such additional methods, features, and advantages be included within this description, be within the scope of the present invention, and be protected by any claims in a patent application which may subsequently filed with respect to the present invention.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an exemplary utensil of the present invention with a partial coating.

FIG. 2 is a top view of an exemplary utensil of the present invention wherein the coating is applied to the entire top surface of the head of the utensil.

FIG. 3 is a side view of the utensil of FIG. 2.

FIG. 4 is a top view of an exemplary utensil of the present invention wherein the coating is applied to the edges of the head of the utensil, on both the top and bottom faces.

FIG. 5 is a side view of the utensil of FIG. 4.

FIG. 6 is a top view of an exemplary utensil of the present invention, wherein the coating is applied to the outer surfaces of the head of the utensil.

FIG. 7 is a side view of the utensil of FIG. 6, showing a cutaway view of the coating with the exposed base material underneath.

### DETAILED DESCRIPTION OF THE PREFERRED EMBODIMENT

The present invention is any cooking utensil, serving utensil, eating utensil, barbecue utensil or other related tableware that is coated with a coating that provides certain benefits to the tableware. The preferred embodiments of the present invention include a novel coating; novel utensils that include either a novel improved coating, or a conventional coating in a novel formation; a method of applying a novel coating to utensils or tableware and a novel method of applying novel or conventional coatings to utensils and/or tableware.

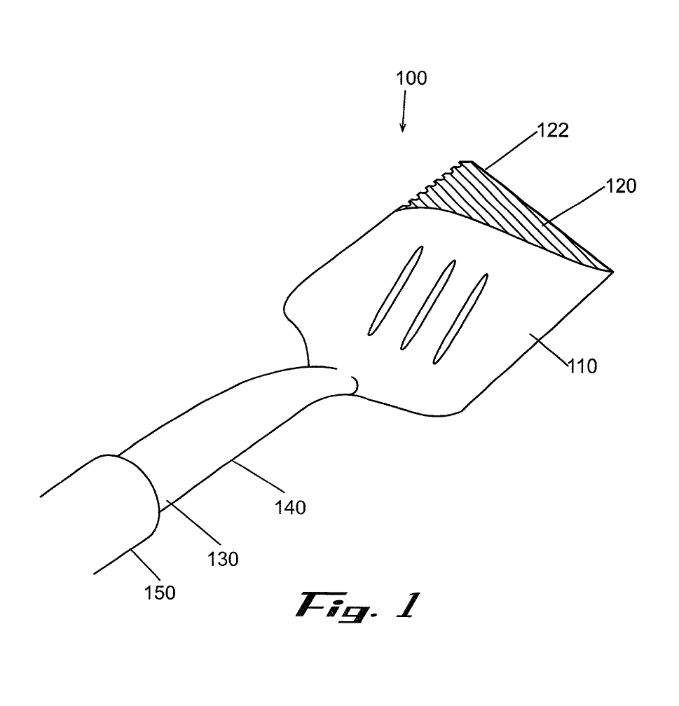

While many different embodiments and utensils comprise the present invention, FIG. 1 is a perspective view of one exemplary embodiment of the present invention. The utensil 100 comprises a handle 130 and a head 110. The handle may comprise a metal or plastic portion 140 attached to the head 110, and a rubber-like or resin portion 150 attached to the metal or plastic portion 140. Either the metal or plastic portion 140 and/or the rubber-like or resin portion 150 may be elongated a sufficient amount to avoid exposure to excessive heat from a cooking apparatus.

The head 110 of the utensil 100 may comprise a base of metal or plastic. The metal is chosen from, for example but not limited to, stainless steel, silver (Ag) or aluminum (Al). The head 110 may further be coated with a coating 120 over the entire surface or only on the surface of a working edge 122.

The coating 120 improves the characteristics of the utensil or tableware by providing one or more of the following benefits, including but not limited to: appearance, hardness, strength, ease of cleaning, resilience, sharpness, durability, improved scratch resistance, reduced scratching of objects which the utensil or tableware contacts, enhanced edge-holding ability of the utensil, and/or minimized deflection of the utensil or tableware upon exposure to extreme heat. The coating 120 of the present invention further may not be abraded upon contact with metal, such as cast iron, and other cooking surfaces, and may not abrade the cooking surface itself. The coating 120 may have the characteristics of being for example, but not limited to any one, all, or combination of the following: dishwasher safe, non-toxic, lightweight, and/or able to withstand extreme temperatures.

The coating 120 in a preferred embodiment is chosen from any one, all, or any combination of the following: titanium aluminum nitride (TiAlN), titanium nitride (TiN), titanium carbonitride (TiCN), chromium nitride (CrN), zirconium nitride (ZrN), chrome, Teflon®, paint, brass, copper, and/or Nylon®. The coating 120 in a more preferred embodiment is chosen from any one, all or any combination of the following: TiAlN, TiN, TiCN, CrN, and/or ZrN. In a most preferred embodiment, the coating 120 is TiAlN.

The coating 120 may also be applied only to the edges of the implement or utensil and as such, may include any one, all, or a combination of titanium aluminum nitride (TiAlN), titanium nitride (TiN), titanium carbonitride (TiCN), chromium nitride (CrN), zirconium nitride (ZrN), chrome, Teflon®, paint, brass, copper, and/or Nylon®. The coating 120 in a more preferred embodiment is chosen from any one, all or any combination of the following: TiAlN, TiN, TiCN, CrN, and/or ZrN. In a most preferred embodiment, the coating 120 is TiAlN.

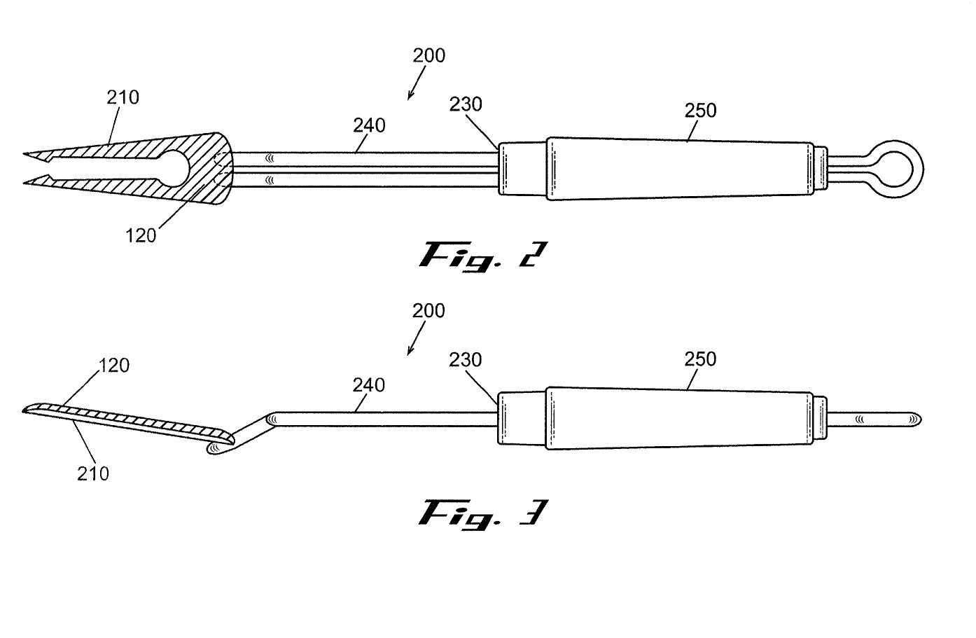

FIG. 2 is a top view of another exemplary embodiment of the present invention. The utensil 200 comprises a handle 230 and a head 210. The handle may comprise a metal or plastic portion 240 and a rubber-like or resin portion 250. Either the metal and/or plastic portion 240 or the rubber-like or resin portion 250 may be elongated a sufficient amount to avoid exposure to excessive heat from a cooking apparatus. In this embodiment, the coating 120 covers the entire top surface of the head 210. FIG. 3 is a side view of the utensil 200 of FIG. 2. It can be more clearly viewed that the coating 120 covers the entire top surface of the head 210 of the utensil 200.

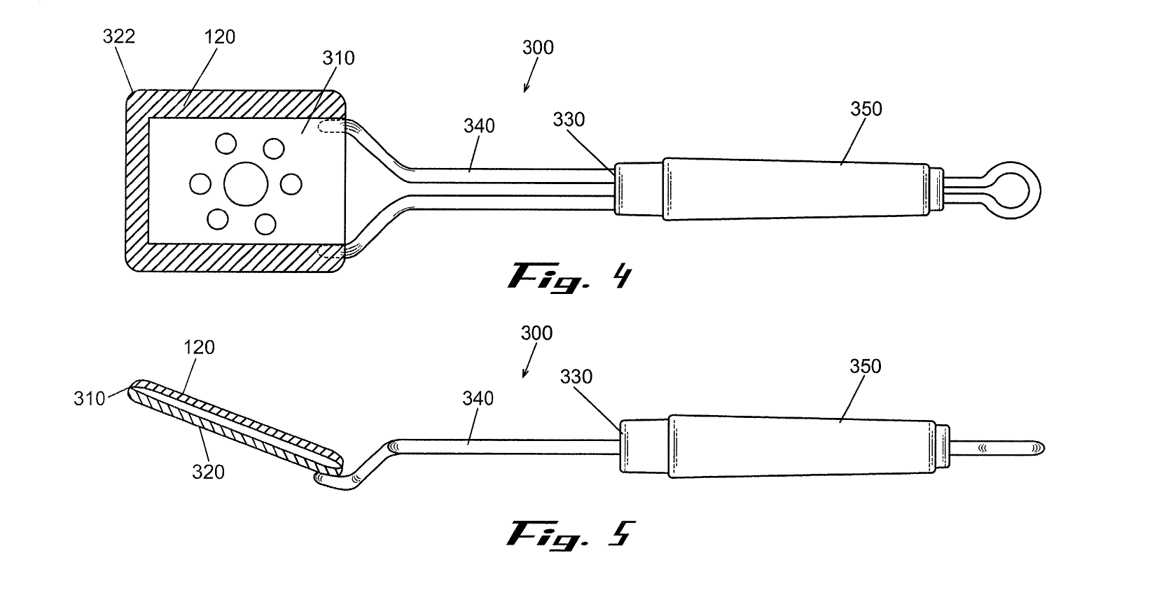

FIG. 4 is a top view of another exemplary embodiment of the present invention.

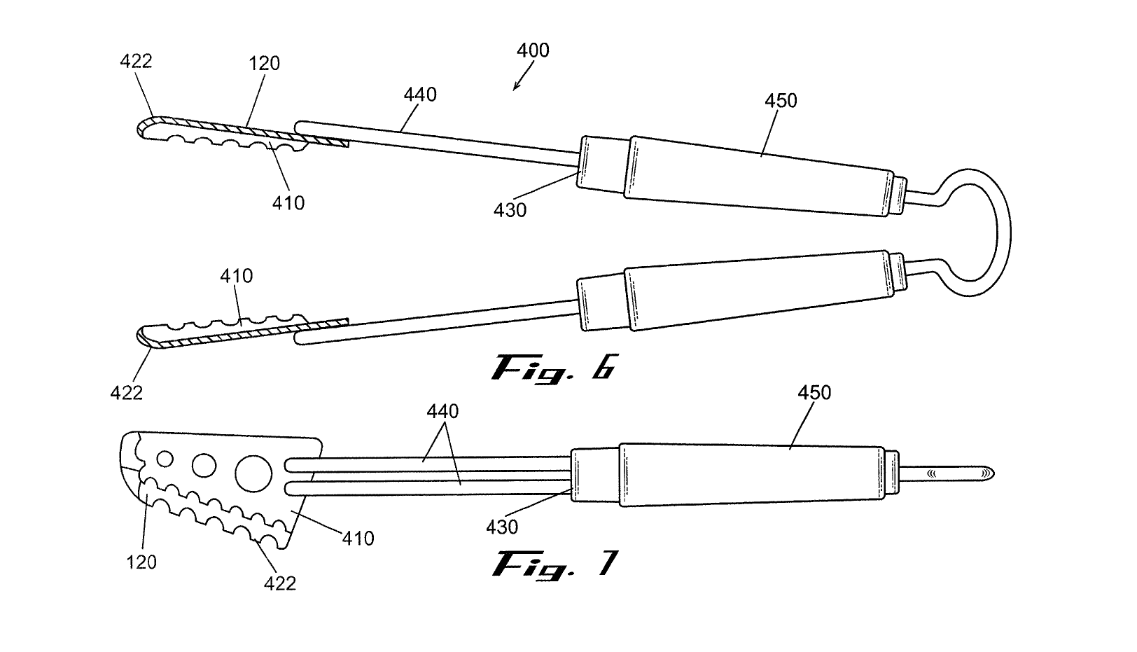

The utensil 300 comprises a handle 330 and a head 310. The handle may comprise a metal or plastic portion 340 and a rubber-like or resin portion 350. Either the metal and/or plastic portion 340 or the rubber-like or resin portion 350 may be elongated a sufficient amount to avoid exposure to excessive heat from a cooking apparatus. In this embodiment, the coating 120 covers both the top and bottom surfaces of the working edge 322 of the head 310. FIG. 5 is a side view of the utensil 300 of FIG. 4. It can be more clearly viewed that the coating 120 covers both the top and bottom surfaces of the head 210 of the utensil 300.

FIG. 6 is a top view of another exemplary embodiment of the present invention.

The utensil 400 comprises a handle 430 and a head 410. The handle may comprise a metal or plastic portion 440 and a rubber-like or resin portion 450. Either the metal and/or plastic portion 440 and/or the rubber-like or resin portion 450 may be elongated a sufficient amount to avoid exposure to excessive heat from a cooking apparatus. In this embodiment, the coating 120 covers both the inner and outer surfaces of the head 410. FIG. 7 is a side view of the utensil 400 of FIG. 6. The relationship between the layer of coating 120 and the base of the head 410 can be more clearly viewed from the cutaway portion of the working edge 422, in that the cutting away of the coating 120 exposes the base of metal or plastic.

The present invention also includes a method of producing a cooking utensil or piece of tableware. A preferred method may include the steps of: providing the utensil, and applying the coating 120 of the present invention to the utensil. The coating 120 may be applied to the utensils and tableware of the present invention in any known method of application of conventional non-stick coating to cookware, utensils, or tableware. The coating 120 may be applied from any method chosen from, including for example but not limited to, electroplating, baking, spraying, and/or dipping the relevant utensil or tableware into the coating. One skilled in the art would understand that the metal or plastic base of the utensil or tableware might need to be prepared in order for proper adhesion of the coating 120 to occur. Preparation of the base may include for example, but is not limited to, roughening the surface of the base on a macro- or molecular level for receiving the coating 120, or applying an intermediate beaded layer to promote adherence thereto.

The present invention also includes a novel method for applying conventional coatings to utensils and tableware. The coating, instead of being applied to the entire surface of the utensil or tableware, may be applied only to the working edge of the utensil or the working portion of the tableware. As depicted in FIG. 1, the coating 120 is applied only to working edge 122. Application of the coating 120 to the working edge 122 results in benefits which include, but are not limited to, utensils and tableware that are lighter, less expensive, and novel in appearance and function. The preferred method if this embodiment comprises the steps of providing a utensil or piece of tableware; and either applying the coating to the entire surface and then abating or etching off the portion of coating 120 not on the working edge, or applying the coating 120 only to the working edge 122 in accordance with a stencil, screen or other means of depositing the coating 120 on the working edge 122 of the utensil.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by any claims which may later be filed in a utility patent application related to the present invention.

Now therefore, the following is claimed:

1. An apparatus for use with the preparation and serving of food, the apparatus comprising:
a utensil, wherein the utensil is configured with a head; and
a coating disposed on a surface of the head of the utensil.

2. The apparatus of claim 1, wherein the coating is disposed on more than one surface of the head of the utensil.

3. The apparatus of claim 1, wherein the coating is disposed only on a portion of the surface of the head of the utensil.

4. The apparatus of claim 3, wherein the coating is disposed on a working edge of the head of the utensil.

5. The apparatus of claim 1, wherein the coating is at least one material selected from the group consisting of:
titanium aluminum nitride, titanium nitride, titanium carbonitride, chromium nitride, zirconium nitride, chrome, Teflon®, paint, brass, copper, or Nylon®.

6. The apparatus of claim 1, wherein the utensil further comprises a cooking utensil.

7. The apparatus of claim 1, wherein the utensil further comprises a serving utensil.

8. The apparatus of claim 1, wherein the utensil further comprises an eating utensil.

9. The apparatus of claim 1, wherein the utensil further comprises a barbecue utensil.

10. A method of producing an apparatus for use with the preparation and serving of food, the method comprising the steps of:
providing a utensil, the utensil configured with a head; and
adhering a coating to a surface of the head of the utensil, so as to improve at least one characteristic of the utensil.

11. The method of claim 10, wherein the step of adhering further comprises adhering the coating to a plurality of surfaces of the head of the utensil.

12. The method of claim 11, wherein the step of adhering further comprises adhering the coating to a portion of the surface of the head of the utensil.

13. The method of claim 12, wherein the step of adhering the coating to a portion of the surface of the head of the utensil further comprises adhering the coating to the entire surface and abating the coating from all but the desired portion of the surface.

14. The method of claim 12, wherein the step of adhering the coating to a portion of the surface of the head of the utensil further comprises screening the undesired portion of the surface, and applying the coating to the desired portion of the surface.

15. The method of claim 12, wherein the step of adhering further comprises adhering the coating to at least one working edge of the head of the utensil.

16. The method of claim 10, wherein the coating is at least one material selected from the group consisting of:
titanium aluminum nitride, titanium nitride, titanium carbonitride, chromium nitride, zirconium nitride, chrome, Teflon®, paint, brass, copper, or Nylon®.

17. The method of claim 16, wherein the method further comprises the step of preparing the surface of the head before adhering the coating so as to promote adherence of the coating to the surface.

18. The method of claim 17, wherein the step of preparing the surface further comprises applying an intermediate beaded layer to the surface.

19. The method of claim 17, wherein the step of preparing the surface further comprises roughening the surface.
